(19) United States
(12) Patent Application Publication
(10) Pub. No.: US 2006/0159015 A1
(43) Pub. Date: Jul. 20, 2006

(54) Apparatus and method for transmitting data in a broadband wireless access communication system

(75) Inventors: Jin-Won Seo, Seoul (KR); Kang-Sung Yang, Suwon-si (KR); Jai-Dong Kim, Yongin-si (KR); Jung-Ho Han, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/333,882

(22) Filed: Jan. 18, 2006

(30) Foreign Application Priority Data
Jan. 18, 2005 (KR) 4681-2005

(51) Int. Cl. H04L 12/56; H04L 12/26; H04Q 7/24; H04Q 7/00; H04J 3/22

(52) U.S. Cl. 370/229; 370/395.21; 370/328; 370/338; 370/465; 370/352

(57) ABSTRACT

A method and apparatus is provided for transmitting data in a broadband wireless access communication system. If transmission data is generated, a data packet generator sets information corresponding to a service type of the generated data in a predetermined field of the generated data. A data packet parser parses the set information, and quality-of-service determiner determines a quality-of-service of the data set in the predetermined field according to the parsing result. A data mapper maps the data to transmission traffic according to the determined quality-of-service before transmission.

This application claims the benefit under 35 U.S.C. § 119(a) of an application entitled “Apparatus and Method for Transmitting Data in a Broadband Wireless Access Communication System” filed in the Korean Intellectual Property Office on Jan. 18, 2005 and assigned Ser. No. 2005-4681, the entire contents of which are hereby incorporated by reference.

### BACKGROUND OF THE INVENTION

1. Field of the Invention

The present invention relates generally to a Broadband Wireless Access (BWA) communication system, and in particular, to a data transmission method and apparatus that guarantees quality-of-service (QoS).

2. Description of the Related Art

Extensive research is being conducted into the next generation communication system to provide users with services that guarantee various QoSs at a data rate. In particular, much of the research into the next generation communication system is being carried out to support a high-speed service that guarantees the mobility and QoS for BWA communication systems such as a wireless Local Area Network (LAN) system and a wireless Metropolitan Area Network (MAN) system. A system based on the Institute of Electrical and Electronics Engineers (IEEE) 802.16 standard (IEEE 802.16 communication system) is one of the typical BWA communication systems.

An IEEE 802.16a/d communication system and an IEEE 802.16e communication system, which are the BWA communication systems, are both specified as a communication system employing an Orthogonal Frequency Division Multiplexing (OFDM) scheme and an Orthogonal Frequency Division Multiple Access (OFDMA) scheme (OFDM/OFDMA communication system) to support a broadband transmission network for physical channels of the wireless MAN system. The IEEE 802.16a/d communication system is based on a non-mobile subscriber station (SS), i.e., the sate in which mobility of the SS is never taken into consideration, and also takes into account only the single cell configuration. However, the IEEE 802.16e communication system takes into account the mobility of an SS for the IEEE 802.16a/d communication system. Herein, a mobile SS will be referred to as a mobile station (MS).

FIG. 1 is a diagram illustrating a conventional BWA communication system.

Referring to FIG. 1, the BWA communication system has a multicell configuration, and includes a base station (BS) 101 for controlling each cell 110 among multiple cells, an MS 103 located in the cell 110 to receive a communication service from the BS 101, and an Internet Protocol (IP) network 120 connecting the BS 101 to other BSs that control other cells. The MS 103 provides a user with a communication service provided from the BS 101, and the BS 101 provides control, management and connectivity for the MS 103. The IP network 120 provides a data service including a voice service to the MS 103 via the BS 101. For example, the IP network 120 includes all IP-based networks as well as a network that provides Internet applications such as e-mail or World Wide Web (WWW) access.

In order to stably provide users with various high-speed services using limited radio resources, the BWA communication system needs to efficiently manage the limited radio resources and guarantee a QoS. In particular, the IEEE 802.16e communication system, which is the typical BWA communication system, supports various schemes proposed for guaranteeing a QoS according to an upper application in a Medium Access Control (MAC) layer. Herein, a packet provided from an upper layer will be referred to as an IP data packet. The IP data packet includes an IP for Layer 3, and a Transmission Control Protocol (TCP) and a User Data packet Protocol (UDP) for Layer 4.

FIG. 2 is a diagram illustrating a structure of an IP data packet in a general BWA communication system.

Referring to FIG. 2, an IP data packet 200 for the BWA communication system includes an IP 201, a TCP 203, a UDP 205 and data 207. A set QoS value of the IP data packet 200 provided from an upper layer is parsed in the IP 201, the TCP 203 or the UDP 205 among the protocols of the IP data packet 200. The parsed set value is compared with a threshold, predetermined by a user, and the QoS is guaranteed if the two values are coincident with each other. A detailed description will now be made of the IP 201, the TCP 203 and the UDP 205 with reference to FIGS. 3A through 3C.

FIGS. 3A through 3C are diagrams illustrating structures of the protocols of the IP data packet 200 shown in FIG. 2 Specifically, FIG. 3A is a diagram illustrating a header format of the IP 201, FIG. 3B is a diagram illustrating a header format of the TCP 203, and FIG. 3C is a diagram illustrating a header format of the UDP 205.

Referring to FIGS. 3A through 3C, as described above, a set QoS value of the IP data packet 200 is parsed in a protocol field 301 of the IP 201, a source port number field 303 or a destination port number field 305 of the TCP 203, or a source port number field 307 or a destination port number field 309 of the UDP field 205. The set QoS value is parsed in at least one of the fields 301, 303, 305, 307 and 309, and the parsed set value is compared with a threshold predetermined by a user.

However, it is not possible to correctly distinguish an upper application of the IP data packet 200 using the set QoS value of the IP data packet 200, parsed in at least one of the fields 301, 303, 305, 307 and 309. For example, if the upper application is a real-time service such as a Voice over Internet Protocol (VoIP), it is necessary to guarantee the QoS by correctly distinguishing the set QoS value parsed in at least one of the fields 301, 303, 305, 307 and 309, but it is not possible to correctly distinguish the set QoS value in a MAC layer of the BWA communication system. Particularly, in the real-time service such as the VoIP, it is hard to distinguish a parsed field among the fields 301, 303, 305, 307 and 309. The failure to correctly distinguish the upper application for a data packet delivered from an upper layer causes a failure to guarantee the QoS when various high-speed services are provided to users.

### SUMMARY OF THE INVENTION

It is, therefore, an object of the present invention to provide an apparatus and method for transmitting data in a BWA communication system.

It is another object of the present invention to provide a data transmission apparatus and method for guaranteeing a QoS in a BWA communication system.

According to one aspect of the present invention, there is provided a method for transmitting data in a broadband wireless access (BWA) communication system. The method includes if transmission data is generated, setting information corresponding to a service type of the generated data in a predetermined field of the generated data; parsing the set information and determining quality-of-service of the data set in the predetermined field according to the parsing result; and mapping the data to transmission traffic according to the determined quality-of-service before transmission.

According to another aspect of the present invention, there is provided an apparatus for transmitting data in a broadband wireless access (BWA) communication system. The apparatus includes a generator for, if transmission data is generated, setting information corresponding to a service type of the generated data in a predetermined field of the generated data; a parser for parsing the set information; a determiner for determining quality-of-service of the data set in the predetermined field according to the parsing result; and a mapper for mapping the data to transmission traffic according to the determined quality-of-service before transmission.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a conventional BWA communication system;

FIG. 2 is a diagram illustrating a structure of an IP data packet in a general BWA communication system;

FIG. 3A is a diagram illustrating an IP header format of the IP data packet shown in FIG. 2;

FIG. 3B is a diagram illustrating a TCP header format of the IP data packet shown in FIG. 2;

FIG. 3C is a diagram illustrating a UDP header format of the IP data packet shown in FIG. 2;

FIG. 4 is a diagram illustrating a structure of a data transmission apparatus in a BWA communication system according to an embodiment of the present invention;

FIG. 5 is a diagram illustrating an IP header format of an IP data packet in a BWA communication system according to an embodiment of the present invention;

FIG. 6A is a diagram illustrating a structure of the ToS field of FIG. 5 in a BWA communication system according to an embodiment of the present invention;

FIG. 6B is a diagram illustrating bit values of a precedence field in a BWA communication system according to an embodiment of the present invention;

FIG. 6C is a diagram illustrating bit values of a precedence field for VoIP and an image service, used for supporting a service type, in a BWA communication system;

FIG. 7A is a diagram illustrating a structure of an IP ToS field of an IP data packet in a BWA communication system according to an embodiment of the present invention;

FIG. 7B is a diagram illustrating a structure of the Differentiated Service Code Point (DSCP) field shown in FIG. 7A; and

FIG. 8 is a flowchart illustrating a procedure for guaranteeing a QoS in a MAC layer of a data transmission apparatus in a BWA communication system according to an embodiment of the present invention.

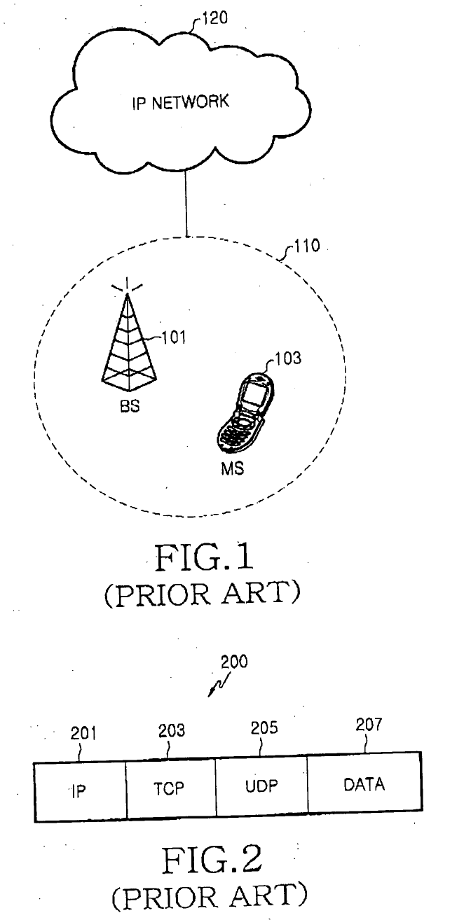

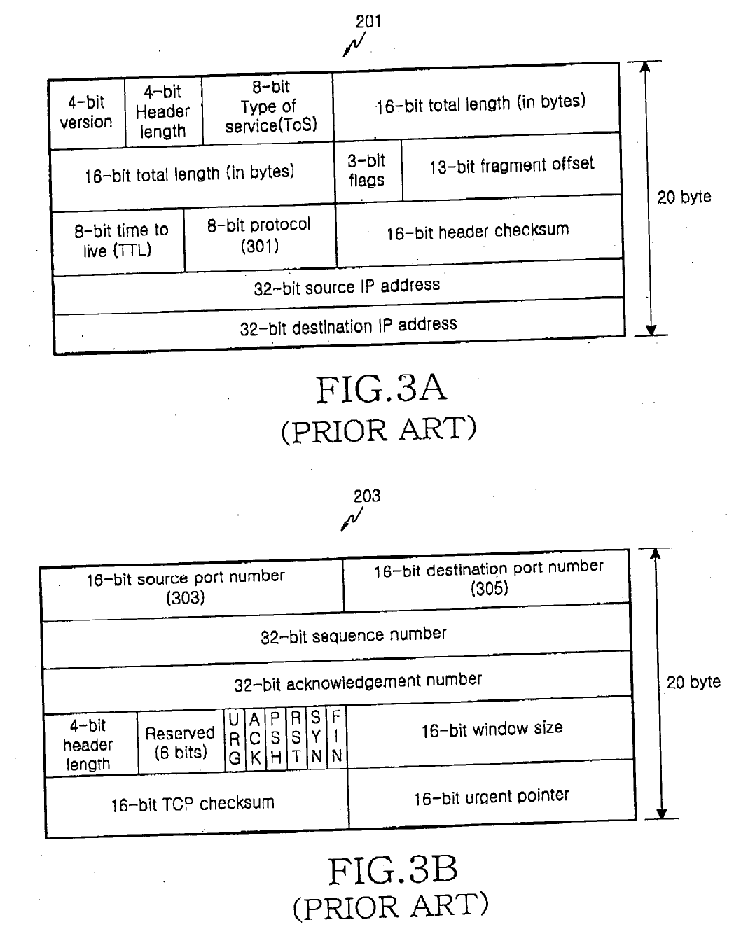

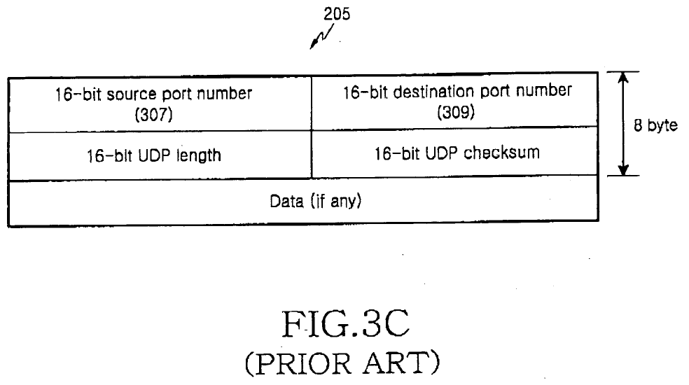

### DETAILED DESCRIPTION OF PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

The present invention proposes a method and apparatus for transmitting data in a Broadband Wireless Access (BWA) communication system, for example, an Institute of Electrical and Electronics Engineers (IEEE) 802.16e communication system. In addition, the present invention proposes a data transmission method and apparatus for guaranteeing the stable Quality-of-Service (QoS) when a transmitter, for example a base station (BS), transmits the data received from an upper layer to a receiver, for example a mobile station (MS), by efficiently using limited resources in a BWA communication system. The present invention proposes a data transmission method and apparatus for generating a transmission data packet including a set QoS value for the data transmitted from an upper layer of a BS, for example an upper layer of a Medium Access Control (MAC) layer, parsing the generated transmission data packets from the upper layer in the MAC layer, and guaranteeing different QoSs according to the parsed information. Although an embodiment of the present invention will be described with reference to an IEEE 802.16e communication system, which is a BWA communication system, specified as a communication system employing an Orthogonal Frequency Division Multiplexing (OFDM) scheme and an Orthogonal Frequency Division Multiple Access (OFDMA) scheme (OFDM/OFDMA communication system), the present invention can also be applied to other communication systems as well as the IEEE 802.16e communication system.

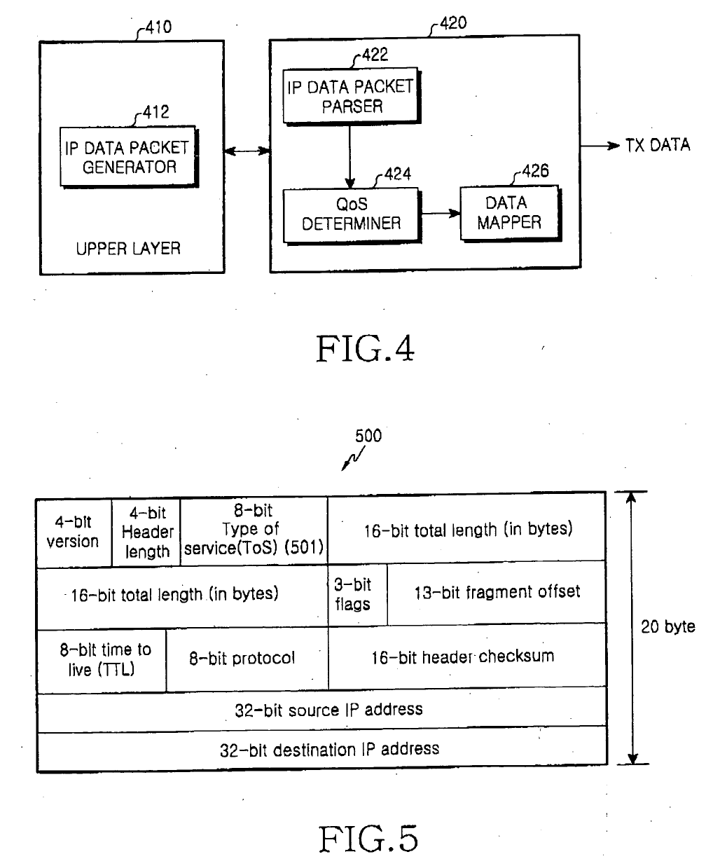

FIG. 4 is a diagram illustrating a structure of a data transmission apparatus in a BWA communication system according to the present invention.

Referring to FIG. 4, the data transmission apparatus for a BWA communication system includes constituent elements implemented in a MAC layer 420 and a constituent element implemented in an upper layer 410 of the MAC layer 420 of a protocol stack for data transmission. More specifically, in the data transmission apparatus, the upper layer 410 includes an Internet Protocol (IP) data packet generator 412 for generating packet data and delivering the generated packet data to the MAC layer 420, and the MAC layer 420 includes an IP data packet parser 422 for parsing the IP data provided from the IP data packet generator 412, i.e., analyzing a service type of the IP data, a QoS determiner 424 for determining a QoS according to the parsing result of the IP data packet parser 422, and a data mapper 426 for mapping the IP data to transmission traffic through scheduling according to the QoS determined by the QoS determiner 424 and transmitting the data to the user. In other words, the IP data packet generator 412 is implemented in the upper layer 410, i.e., Layer 3, of the MAC layer 420 in a protocol stack, and the IP data packet parser 422, the QoS determiner 424, and the data mapper 426 can be implemented in the MAC layer 420, i.e., Layer 4.

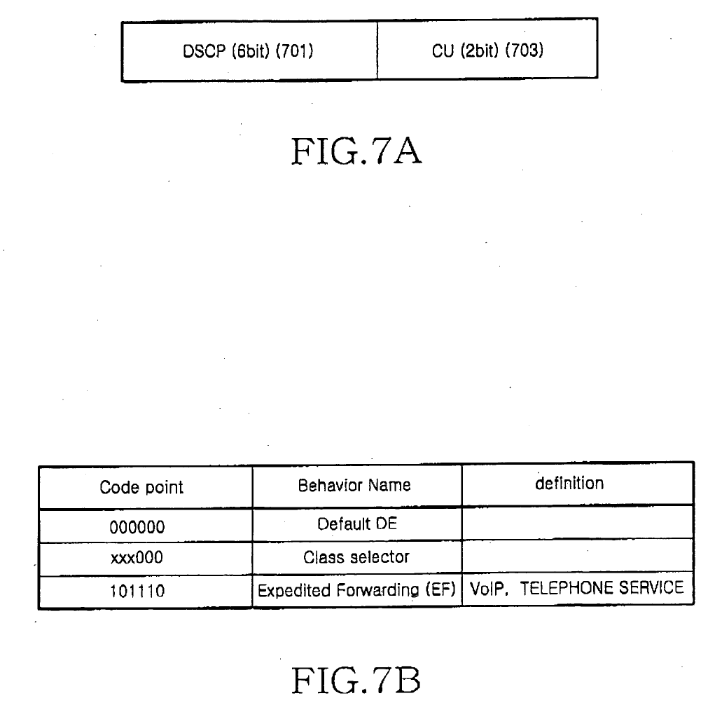

The IP data packet generator 412 represents a QoS using a one of several fields of an IP data packet. For example, when IPv4 is used as an IP of a data packet, the IP data packet generator 412 represents a necessary QoS using a Type of Service (ToS) field shown in FIG. 5, and when IPv6 is used as an IP of the data packet, the IP data packet generator 412 represents a necessary QoS using a Traffic Class field or a Flow Label file shown in FIG. 7A.

The IP data packet, as described with reference to FIG. 2, includes an IP, a Transmission Control Protocol (TCP), a User Data packet Protocol (UDP), and data. Herein, a description will first be made of a scheme for representing a QoS when IPv4 is used as an IP of a data packet, and next, a description will be made of a scheme for representing a QoS when IPv6 is used as an IP of the data packet.

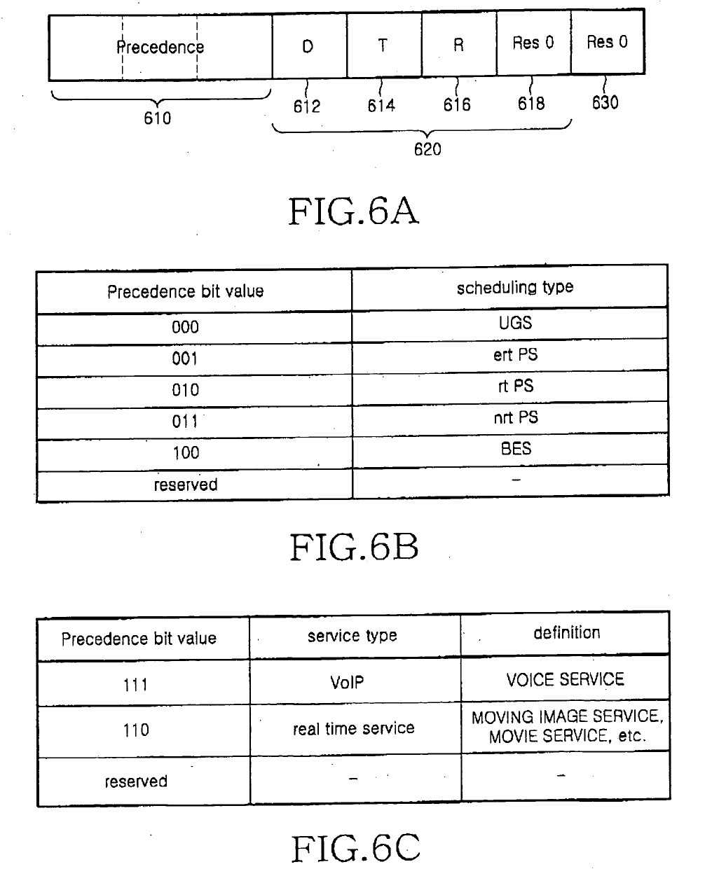

With reference to FIGS. 5 and 6A, a description will now be made of a method for representing a QoS using the ToS field when IPv4 is used as an IP of the data packet.

FIG. 5 is a diagram illustrating an IP header format of an IP data packet in a BWA communication system according to the present invention.

Referring to FIG. 5, an IP of the IP data packet uses an 8-bit ToS field 501 to select an actual parameter that should be used when the IP data packet is transmitted via a network. In this case, the IP data packet generator 412 identifies an application for an IP data packet to be transmitted, and represents in the ToS field 501 a QoS appropriate for the identified application. In particular, the IP data packet generator 412 uses a precedence field in the ToS field 501.

FIG. 6A is a diagram illustrating a structure of the ToS field 501 of FIG. 5 in a BWA communication system according to the present invention.

Referring to FIG. 6A, the ToS field 501 includes a 3-bit Precedence field 610, a 4-bit ToS field 620, and a 1-bit Reserved field 630.

The 3-bit Precedence field 610 has a value 0 representing delivery of an IP data packet through a value 7 representing Network Control. In the 4-bit ToS field 620, three bits D 612, T 614 and R 616 are used for setting delay, throughput, and reliability required by each IP data packet, respectively. The last bit Res_0 618 of the 4-bit ToS field 620 is used for minimizing the monetary cost.

The IP data packet generator 412 can designate a priority of a corresponding IP data packet using the 3-bit Precedence field 610 in the ToS field 501. Each application data is assigned a priority in the network control traffic. That is, the IP data packet generator 412 can identify real-time application data such as VoIP data using precedence bits of the Precedence field 610 in the ToS field 501, and represent the identified data using the 3 bits of the Precedence field 610. The 3 bits of the Precedence field 610 can be generated as shown in FIGS. 6B or 6C.

FIGS. 6B and 6C are diagrams illustrating bit values of the Precedence field 610 of FIG. 6A for application data in a BWA communication system according to the present invention. Specifically, FIG. 6B is a diagram illustrating bit values of the Precedence field 610 for a scheduling type, used for supporting application data, i.e., a service type. FIG. 6C is a diagram illustrating bit values of the Precedence field 610 for VoIP and an image service, used for supporting a service type. Referring to FIG. 6B, the BWA communication system supports an Unsolicited Granted Service (UGS) type, an extended real-time Polling Service (ertPS) type, a real-time Polling Service (rtPS) type, a non-real-time Polling Service (nrtPS) type, and a Best Effort Service (BES) type.

The UGS type represents a real-time service in which the same-sized data, i.e., the same bandwidth is periodically allocated while an access is maintained. Generally, voice transmission corresponds to the UGS type, and the UGS type is applied to VoIP and E1/T1. For the UGS type, a Maximum Sustained Traffic Rate parameter, a Maximum Reserved Traffic Rate parameter, a Maximum Latency parameter, a Tolerated Jitter parameter, and a QoS Service flow parameter of a request/transmission policy are taken into consideration. Among the parameters, the Maximum Sustained Traffic Rate parameter and the Maximum Reserved Traffic Rate parameter are QoS parameters require the highest consideration. A piggyback request is not approved for including other signals in the exiting signal during data transmission, and bandwidth stealing is also not approved. In addition, Phase Modulation (PM) bits are used for requesting a need for a bandwidth for unicast poll or non-UGS accesses in polling in which a state of a receiver receiving a service is continuously checked. For an IP data packet of the UGS type, precedence bits of the Precedence field 610 in the ToS field 501 have a value of 000.

The ertPS type supports a function for preventing resources from being allocated for a call interval that does not affect the QoS. For example, in an uplink, a MS informs a BS of the non-necessity of resource allocation for an uplink burst transmission before a start of a silence spurt interval that does not affect the QoS. If the call is resumed, the MS sends a resource allocation request to the BS using a codeword designated in a Channel Quality Indicator Channel (CQICH). In response to the request, the BS allocates possible available resources to the MS and transmits uplink data bursts with the allocated resources. For an IP data packet of the ertPS type, precedence bits of the Precedence field 610 in the ToS field 501 have a value of 001.

The rtPS type represents a real-time service in which a variable bandwidth should be continuously allocated while an access is maintained. The rtPS type may be applied to Moving picture Experts Group (MPEG) video. For the rtPS type, a Maximum Sustained Traffic Rate parameter, a Maximum Reserved Traffic Rate parameter, a Maximum Latency parameter, and a designated QoS Service flow parameter of a request/transmission policy are taken into consideration. A piggyback request is approved, and bandwidth stealing is also approved. Only the unicast polling is possible for the polling. For an IP data packet of the rtPS type, precedence bits of the Precedence field 610 in the ToS field 501 have a value of 010.

The nrtPS type represent a non-real-time service that services delay-allowed data streams comprised of variable-size data having a minimum data rate. The nrtPS type is applied to a File Transfer Protocol (FTP). For the nrtPS type, a Maximum Sustained Traffic Rate parameter, a Maximum Reserved Traffic Rate parameter, a Traffic Priority parameter, and a designated QoS Service flow parameter of a request/transmission policy are taken into consideration. A piggyback request is approved, and bandwidth stealing is also approved. Only the unicast polling is possible or all types of polling are possible, for the polling. For an IP data packet of the nrtPS type, precedence bits of the Precedence field 610 in the ToS field 501 have a value of 011.

The BES type represents a service that services data streams that do not require a minimum service level. For the BES type, a Maximum Sustained Traffic Rate parameter, a Traffic Priority parameter, and a designated QoS Service flow parameter of a request/transmission policy are taken into consideration. The BES type may be applied to a Web service, and both a piggyback request and bandwidth stealing are approved. All types of polling are possible for the polling. For an IP data packet of the BES type, precedence bits of the Precedence field 610 in the ToS field 501 have a value of 100.

If a predetermined one of the foregoing service types is used, the IP data packet generator 412 transmits an IP data packet after setting the Precedence field 610 of the ToS field 501 such that it has a bit value corresponding to each service type. Then the IP data packet parser 422 parses the ToS field 501 of the IP data packet transmitted by the IP data packet generator 412, i.e., analyzes a bit value of the Precedence field 610 of the ToS field 501, and the QoS determiner 424 determines a QoS for the IP data packet using the bit value of the Precedence field 610, analyzed by the IP data packet parser 422. The data mapper 426 detects a scheduling type for transmitting the IP data packet to the user according to the determined QoS, performs scheduling according to the detected scheduling type, and transmits the data to the user after mapping the scheduling result to the transmission traffic.

Referring to FIG. 6C, the BWA communication system supports a VoIP service type, i.e., a voice service type, and an image service type. When a user uses a VoIP service, the IP data packet generator 412 transmits an IP data packet after setting precedence bits of the Precedence field 610 in the ToS field 501 to ‘111’. When the user uses a real time service such as a moving image service and a movie service, the IP data packet generator 412 transmits an IP data packet after setting precedence bits of the Precedence field 610 in the ToS field 501 to ‘110’. A detailed description thereof has been given with reference to FIG. 6B.

When IPv6 is used as an IP of a data packet, the IP data packet generator 412 expresses the QoS using an IP ToS field defined in IPv6 instead of the ToS field 501 for an IP data packet.

With reference to FIGS. 7A and 7B, a description will now be made of a method of expressing a QoS using the IP ToS field defined in IPv6 as an IP of the data packet.

FIGS. 7A and 7B are diagrams illustrating structures of an IP ToS field in a BWA communication system according to the present invention. Specifically, FIG. 7A is a diagram illustrating a structure of the IP ToS field, i.e., a structure of an 8-bit Traffic Class field, and FIG. 7B is a diagram illustrating a structure of the Differentiated Service Code Point (DSCP) field shown in FIG. 7A.

Referring to FIG. 7A, in the BWA communication system, an IP ToS field of an IP data includes a 6-bit DSCP field 701 and a 2-bit Currently Unused (CU) field 703.

The IP data packet generator 412 can set a priority of a corresponding data packet in the 6 DSCP bits. More specifically, the IP data packet generator 412 can identify real-time application data such as VoIP data, and express the identified data using the 6 DSCP bits. The 6-bit DSCP can be generated as shown in FIG. 7B.

Referring to FIG. 7B, the IP data packet generator 412 guarantees the QoS by defining an Expedited Forwarding (EF) of the DSCP field 701 as VoIP and expressing a QoS mapped to the EF.

When IPv4 is used as an IP of a data packet, the IP data packet generator 412 transmits the IP data packet after setting a QoS through the ToS field 501. When IPv6 is used as an IP of a data packet, the IP data packet generator 412 transmits the IP data packet after setting a necessary QoS using the 8-bit Traffic Class field, which is a ToS field.

When a set QoS value according to an embodiment of the present invention interworks with the 4-bit ToS field or when the communication system does not support the ToS field, the IP data packet generator 412 transmits the IP data packet after setting the 4-bit value to ‘1000’ for minimizing a delay, or ‘0100’ for maximizing throughput. When IPv6 is used as an IP of a data packet, the IP data packet generator 412 can define any one of an 8-bit Traffic Class field and a 20-bit Flow Label field as shown in FIGS. 6A and 6B, to guarantee the QoS. Thereafter, the IP data packet generator 412 transmits the IP data packet to the MAC layer 420. The IP data packet parser 422 in the MAC layer 420 parses the IP data packet transmitted from the IP data packet generator 412 in the upper layer 410, and outputs the parsed IP data packet to the QoS determiner 424.

When IPv4 is used as an IP of the data packet, the QoS determiner 424 can determine a QoS of the corresponding IP data packet from the parsed IP data packet based on the ToS field 501. When IPv6 is used as an IP of the data packet, the QoS determiner 424 can determine a QoS of the corresponding IP data packet from the parsed IP data packet based on any one of the 8-bit Traffic Class field and the 20-bit Flow Label field. The QoS determiner 424 outputs the determined QoS of the IP data packet to the data mapper 426. The data mapper 426 maps the corresponding IP data packet to transmission traffic according to the QoS provided from the QoS determiner 424, and transmits the mapped data to the user.

Although the IP data packet parser 422, the QoS determiner 424 and the data mapper 426 can be separately implemented in the data transmission apparatus for the BWA communication system as shown in FIG. 4, they can also be implemented on an integrated basis. Therefore, the present invention is not limited to the foregoing structure of the data transmission apparatus according of the present invention.

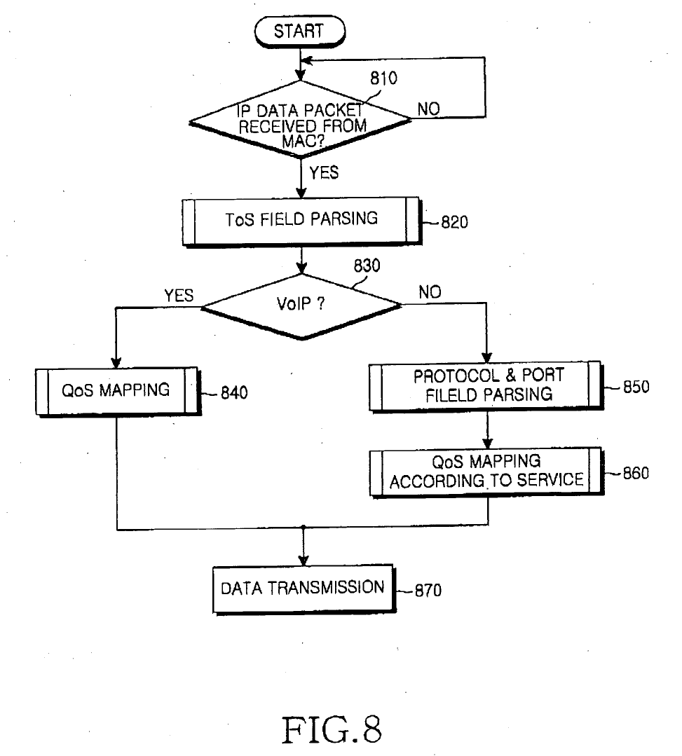

FIG. 8 is a flowchart illustrating a procedure for guaranteeing a QoS in a MAC layer 420 of a data transmission apparatus in a BWA communication system according to the present invention.

Referring to FIG. 8, a data transmission apparatus determines in step 810 if any IP data packet has been received from an upper layer 410, i.e., an IP data packet generator 412. If any IP data packet is received, the data transmission apparatus parses a ToS field of the received IP data packet in step 820. Thereafter, in step 830, the data transmission apparatus identifies an application, i.e., a service type, of the corresponding IP data packet, and determines if the application is VoIP. Although the service type is limited to the VoIP in FIG. 8, the data transmission apparatus can be implemented to identify the various service types described above.

If it is determined in step 830 that the application is VoIP, the data transmission apparatus appropriately maps the corresponding IP data packet to transmission traffic according to a QoS for a VoIP service in step 840, and then proceeds to step 870. It is also possible to give high priority to the VoIP service, for later use in data scheduling. However, if it is determined in step 830 that the application is not the VoIP, the data transmission apparatus parses a protocol field and a port field of the IP data packet in step 850, and maps the corresponding IP data packet to transmission traffic according to a predetermined service in step 860. Thereafter, the data transmission apparatus transmits the mapped data in step 870.

As can be understood from the foregoing description, according to the present invention, an upper layer sets a QoS value corresponding to a service type of data in predetermined fields of the data, so a MAC layer can easily identify the service type, thereby providing a user with a high-speed service having various QoSs.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting data in a broadband wireless access communication system, the method comprising the steps of:
if transmission data is generated, setting information corresponding to a service type of the generated data in a predetermined field of the generated data;
parsing the set information and determining quality-of-service of the data set in the predetermined field according to the parsing result; and
mapping the data to transmission traffic according to the determined quality-of-service before transmission.

2. The method of claim 1, wherein the step of setting the information corresponding to a service type is set in precedence bits of a service type field according to a protocol of the generated data.

3. The method of claim 1, wherein the step of setting the information corresponding to a service type is set in the differentiated service code point bits of a traffic class field according to a protocol of the generated data.

4. The method of claim 3, wherein the step of setting in the differentiated service code point bits is set the expedited forwarding according to a priority of the generated data.

5. The method of claim 1, wherein the step of setting in a predetermined field of the generated data is set in a flow label field according to a protocol of the generated data.

6. The method of claim 1, wherein the service type of the generated data includes one of an Unsolicited Granted Service type, an extended real-time Polling Service type, a real-time Polling Service type, a non-real-time Polling Service type, and a Best Effort Service type.

7. The method of claim 1, wherein the service type of the generated data includes one of a voice service type and an image service type.

8. The method of claim 1, wherein the step of setting in a predetermined field of the generated data is set in an upper layer of a medium access control layer.

9. An apparatus for transmitting data in a broadband wireless access communication system, the apparatus comprising:
a generator for, if transmission data is generated, setting information corresponding to a service type of the generated data in a predetermined field of the generated data;
a parser for parsing the set information;
a determiner for determining quality-of-service of the data set in the predetermined field according to the parsing result; and
a mapper for mapping the data to transmission traffic according to the determined quality-of-service before transmission.

10. The apparatus of claim 9, wherein the generator sets the information corresponding to a service type in precedence bits of a service type field according to a protocol of the generated data.

11. The apparatus of claim 9, wherein the generator sets the information corresponding to a service type in the differentiated service code point bits of a traffic class field according to a protocol of the generated data.

12. The apparatus of claim 11, wherein the generator sets expedited forwarding in the differentiated service code point bits according to priority of the generated data.

13. The apparatus of claim 9, wherein the generator sets the service type in a flow label field according to a protocol of the generated data.

14. The apparatus of claim 9, wherein the service type of the generated data includes one of an Unsolicited Granted Service type, an extended real-time Polling Service type, a real-time Polling Service type, a non-real-time Polling Service type, and a Best Effort Service type.

15. The apparatus of claim 9, wherein the service type of the generated data includes one of a voice service type and an image service type.

16. The apparatus of claim 9, wherein the parser, the determiner and the mapper set are implemented in a medium access control layer, and the generator is implemented in an upper layer of the medium access control layer.
